(19) United States
(12) Patent Application Publication
(10) Pub. No.: US 2025/0029139 A1
(43) Pub. Date: Jan. 23, 2025

(54) INDUSTRIAL AUTOMATION SOFTWARE UTILITY CREDITING

(71) Applicant: Rockwell Automation Technologies, Inc., Mayfield Heights, OH (US)

(72) Inventors: Leo T. Kilfoy, San Diego, CA (US); Michael J. Tresh, Manchester, NH (US); Bruce T. McCleave, JR., Mission Viejo, CA (US); Daniel C. Rischar, Mayfield Heights, OH (US); Oliver C. Haya, Milwaukee, WI (US); Stephen C. Briant, Moon Township, PA (US); Ryan P. Dunn, Mayfield Heights, OH (US)

(21) Appl. No.: 18/355,581

(22) Filed: Jul. 20, 2023

(51) Int. Cl. G06Q 30/0226; G06Q 30/018; G06Q 30/0235

(52) U.S. Cl. CPC G06Q 30/0233; G06Q 30/018; G06Q 30/0235

(57) ABSTRACT

An industrial software management system uses utility crediting to license industrial software to customers. According to an example licensing structure, a software customer can purchase utility credits that grant the customer use of a software product, limited by a usage metric defined by the utility credits. Depending on the type of software product, the usage metric may be a function of processing usage by the product, an amount of storage consumed by the product, a number of processing cores used, product utilization time, a number of times a specific feature of the product is used, or other such metrics. Utility credits can be as granular and scalable as necessary, and different usage drawdown rates can be defined depending on the type of software application, customer agreements, or other factors.

### TECHNICAL FIELD

The subject matter disclosed herein relates generally to industrial automation systems, and, more specifically, to techniques for licensing industrial software products.

### BACKGROUND ART

The design, operation, and analysis of industrial systems require a diverse range of software products. These include, for example, control program development software for configuring and programming industrial controllers, human-machine interface (HMI) development software for developing HMI applications for execution on HMI terminals, various types of analytic software for collecting and analyzing operational data collected from controlled industrial processes, and other such software products. Typically, these software products must be purchased or leased by owners of the industrial assets from software vendors.

### BRIEF DESCRIPTION

The following presents a simplified summary in order to provide a basic understanding of some aspects described herein. This summary is not an extensive overview nor is it intended to identify key/critical elements or to delineate the scope of the various aspects described herein. Its sole purpose is to present some concepts in a simplified form as a prelude to the more detailed description that is presented later.

In one or more embodiments, a system is provided, comprising a credit tracking component configured to record an allocation of utility credits to an industrial customer in a customer record associated with the industrial customer, the utility credits granting usage of an industrial software product to the industrial customer; a usage monitoring component configured to monitor usage events indicative of the industrial customer's usage of the industrial software product, wherein the usage events are units of a usage metric having a defined cost of utility credits, wherein the credit tracking component is further configured to record a deduction of the utility credits in the customer record in response to detection of each of the usage events by the usage monitoring component; and a software enablement component configured to enable one or more features of the industrial software product in response to determining that a total number of the utility credits is equal to or greater than a defined number of credits, and to disable the one or more features in response to determining that the total number of the utility credits is less than the defined number.

Also, one or more embodiments provide a method, comprising allocating, by a system comprising a processor, utility credits to an industrial customer, wherein the utility credits grant usage of an industrial software product to the industrial customer; monitoring, by the system, usage events indicative of the industrial customer's usage of the industrial software product, wherein the usage events are measures of a usage metric having a defined cost of utility credits; and in response to detecting a usage event of the usage events: deducting, by the system, a number of the utility credits commensurate with the defined cost of utility credits; in response to determining that a remaining number of the utility credits is equal to or greater than a defined number of utility credits, enabling, by the system, one or more features of the industrial software product; and in response to determining that the remaining number of the utility credits is less than the defined number of utility credits, disabling, by the system, the one or more features.

Also, according to one or more embodiments, a non-transitory computer-readable medium is provided having stored thereon instructions that, in response to execution, cause a system to perform operations, the operations comprising allocating utility credits to an industrial customer, wherein the utility credits grant permission to use an industrial software product to the industrial customer; and monitoring usage events indicative of the industrial customer's usage of the industrial software product, wherein the usage events are measures of a usage metric having a defined cost of utility credits; in response to detecting a usage event of the usage events: subtracting a number of the utility credits equal to the defined cost of utility credits; in response to determining that a remaining number of the utility credits is equal to or greater than a defined number of utility credits, enabling one or more features of the industrial software product; and in response to determining that the remaining number of the utility credits is less than the defined number of utility credits, disabling the one or more features.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of an example industrial software management system.

FIG. 3 is a diagram illustrating a general architecture of the industrial software management system.

FIG. 4 is a diagram illustrating tracking of customers' utility credits by the software management system.

FIG. 5 is a diagram illustrating deployment of software activation controls by the system.

FIG. 6 is a diagram illustrating delivery of agreement recommendations.

FIG. 7 is a diagram illustrating generation and delivery of a customer-specific utility credit dashboard to a client device associated with a corresponding customer.

FIG. 8 is a diagram of an example industrial software management system.

FIG. 9 is a diagram illustrating a general architecture of the industrial software management system.

FIG. 10 is a diagram illustrating the process of checking out a software product for use by a user associated with a customer entity.

FIG. 11 is a diagram illustrating the process of relinquishing the instance of the software product.

FIG. 12 is a diagram illustrating an embodiment of the software management system that uses feature tokens to license runtime features of industrial devices and systems.

FIG. 13 is a flowchart of an example methodology for managing licensed use of industrial software products using utility credits.

FIG. 14a is a flowchart of a first part of an example methodology for managing licensed use of industrial software products using subscription tokens.

FIG. 14B is a flowchart of a second part of an example methodology for managing licensed use of industrial software products using subscription tokens.

FIG. 15 is an example computing environment.

FIG. 16 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

Industrial controllers, their associated I/O devices, motor drives, and other such industrial devices are central to the operation of modern automation systems. Industrial controllers interact with field devices on the plant floor to control automated processes relating to such objectives as product manufacture, material handling, batch processing, supervisory control, and other such applications. Industrial controllers store and execute user-defined control programs to effect decision-making in connection with the controlled process. Such programs can include, but are not limited to, ladder logic, sequential function charts, function block diagrams, structured text, or other such platforms.

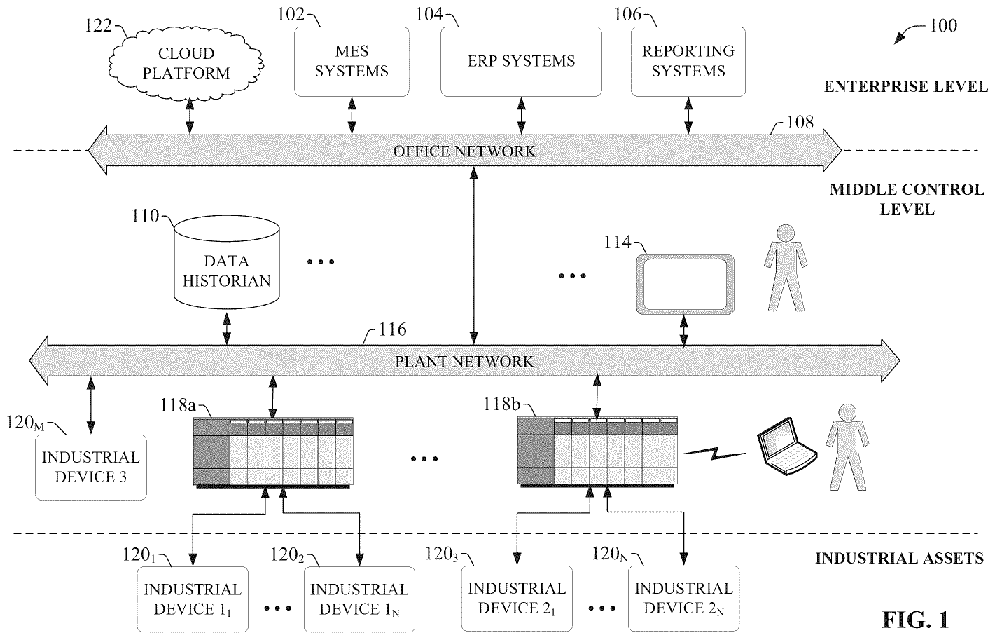

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise any conceivable type of code used to process input signals read from the industrial devices 120 and to control output signals generated by the industrial controllers, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot control inputs, valves, and the like. Some industrial devices, such as industrial device 120_{M}, may operate autonomously on the plant network 116 without being controlled by an industrial controller 118.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over the plant network 116 using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by the control program and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices—including but not limited to motor drives, instruments, or condition monitoring modules—may store data values that are used for control and/or to visualize states of operation. Such devices may also capture time-series data or events on a log for later retrieval and viewing.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a plant network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens through which the operator interacts with the industrial controllers 118, and thereby with the controlled processes and/or systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer. HMIs may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, one or more data historians 110 that aggregate and store production information collected from the industrial controllers 118 and other industrial devices.

Industrial devices 120, industrial controllers 118, HMIs 114, associated controlled industrial assets, and other plant-floor systems such as data historians 110, vision systems, and other such systems operate on the operational technology (OT) level of the industrial environment. Higher level analytic and reporting systems may operate at the higher enterprise level of the industrial environment in the information technology (IT) domain; e.g., on an office network 108 or on a cloud platform 122. Such higher level systems can include, for example, enterprise resource planning (ERP) systems 104 that integrate and collectively manage high-level business operations, such as finance, sales, order management, marketing, human resources, or other such business functions. Manufacturing Execution Systems (MES) 102 can monitor and manage control operations on the control level given higher-level business considerations. Reporting systems 106 can collect operational data from industrial devices on the plant floor and generate daily or shift reports that summarize operational statistics of the controlled industrial assets.

The design, operation, and analysis of industrial systems require a diverse range of software products. These include, for example, control program development software for configuring and programming industrial controllers 118, HMI development software for developing HMI applications for execution on HMI terminals, various types of analytic software for collecting and analyzing operational data collected from controlled industrial processes (e.g., MES software, ERP software, reporting software, etc.), and other such software products. Typically, these software products must be purchased or leased by owners of the industrial assets from software vendors. Many software licensing agreements offered by industrial software vendors are complicated and inflexible, and as such can serve as a barrier to entry for potential new customers, or even discourage a vendor's current customers from purchasing other software products offered by the vendor. More flexible licensing agreements may not only incentivize existing users of a vendor's software products to expand into other more specialized software offerings, but also encourage new customers to purchase the vendor's software solutions.

To address these and other issues, one or more embodiments described herein provide a system for licensing industrial software using utility crediting. According to an example licensing structure, a software customer can purchase utility credits that grant the customer use of a software product, limited by a usage metric defined by the utility credits. Depending on the type of software product, the usage metric may be a function of processing usage by the product, an amount of storage consumed by the product, a number of processing cores used, product utilization time, a number of times a specific feature of the product is used, or other such metrics. Utility credits can be as granular and scalable as necessary, and different usage drawdown rates can be defined depending on the type of software application, customer agreements, or other factors.

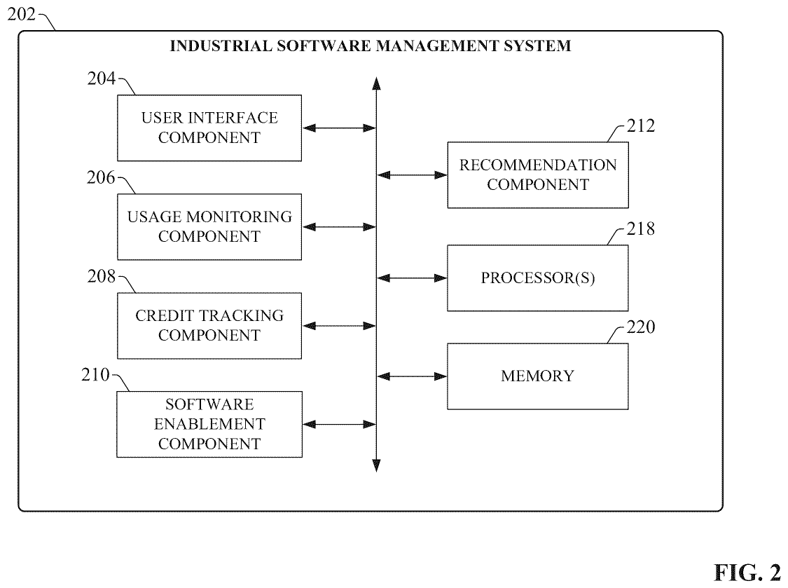

FIG. 2 is a block diagram of an example industrial software management system 202 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Industrial software management system 202 can include a user interface component 204, a usage monitoring component 206, a credit tracking component 208, a software enablement component 210, a recommendation component 212, one or more processors 218, and memory 220. In various embodiments, one or more of the user interface component 204, usage monitoring component 206, credit tracking component 208, software enablement component 21, recommendation component 212, the one or more processors 218, and memory 220 can be electrically and/or communicatively coupled to one another to perform one or more of the functions of the software management system 202. In some embodiments, components 204, 206, 208, 210, and 212 can comprise software instructions stored on memory 220 and executed by processor(s) 218. Software management system 202 may also interact with other hardware and/or software components not depicted in FIG. 2. For example, processor(s) 218 may interact with one or more external user interface devices, such as a keyboard, a mouse, a display monitor, a touchscreen, or other such interface devices.

User interface component 204 can be configured to exchange information between the system 202 and client devices having authorization to access the software management system 202. In some embodiments, user interface component 204 can be configured to generate and deliver interface displays to the client device that allow the user to establish software licensing agreements, purchase utility credits, download software products, view utility credit summaries, or perform other interactions with the system 202.

Usage monitoring component 206 can be configured to monitor usage metrics for respective software products being used by customers for the purposes of credit tracking. Credit tracking component 208 can be configured to update the customers' utility credit counts as a function of the monitored usage metrics. Software enablement component 210 can be configured to enable or disable customer-side software products based on the customers' current utility credit counts. Recommendation component 212 can be configured to assess a customer's expected execution scenarios for a software product, as well as the customer's available processing platforms, and generate recommendations for optimal utility credit agreements based on the assessment.

The one or more processors 218 can perform one or more of the functions described herein with reference to the systems and/or methods disclosed. Memory 220 can be a computer-readable storage medium storing computer-executable instructions and/or information for performing the functions described herein with reference to the systems and/or methods disclosed.

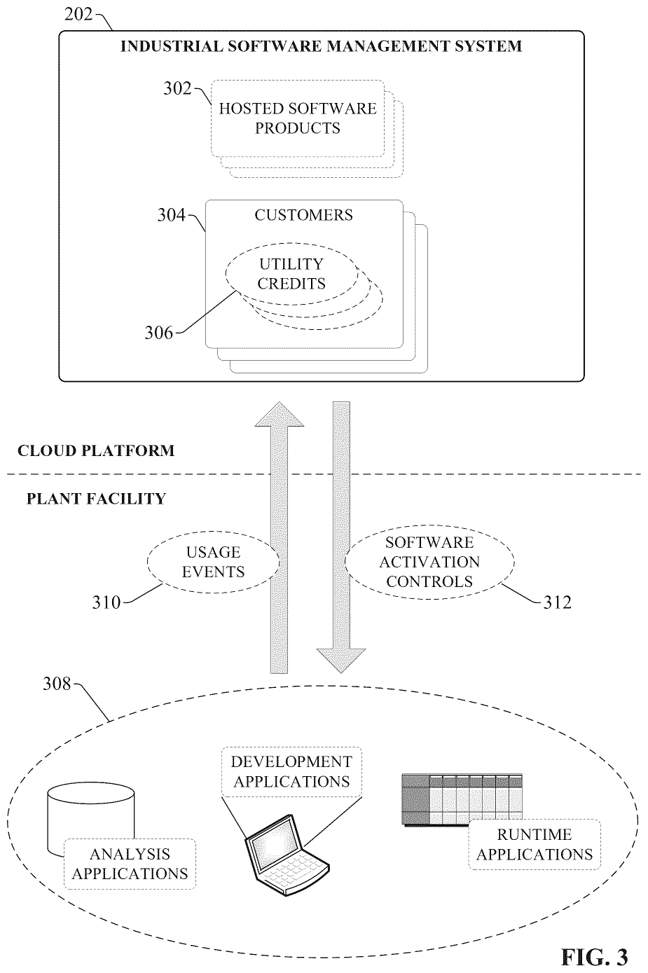

FIG. 3 is a diagram illustrating a general architecture of the industrial software management system 202 according to one or more embodiments. In this example architecture, the software management system 202 resides and executes on a cloud platform, or another web-based platform, and is accessible by multiple industrial customers. The system 202 hosts various industrial software products 302, which are available for licensed use by the customers. These software products 302 can include, but are not limited to, development or design applications for creating portions of a customer's industrial control project; analysis applications for performing analysis on the customer's industrial automation systems or processes for the purposes of optimization, insights, or reporting; runtime applications that execute on control system hardware, or other such software products. Specific types of software products 302 that can be offered and licensed using utility credits 306 can include, but are not limited to, control program development applications used to create executable control programs and device settings for industrial controllers 118 (e.g., ladder logic development programs or other types of controller configuration software), HMI development applications used to create visualization applications for execution on HMI terminals, device configuration software (e.g., motor drive configuration applications), MES software, ERP software, reporting software, data historian applications, industrial simulation or emulation software, or other such industrial software products.

The system 202 allows industrial customers, including owners of industrial assets 308 that operate at different industrial facilities, to establish licensing agreements to use selected software products 302 offered by one or more industrial software vendors. Depending on the type of software product 302, customers having a license to use a selected software product 302 can either download the product 302 from the system 202 for local execution, or may access and use a customer-specific instance of the product 302 that executes on the cloud platform on which the system 202 resides.

The system 202 supports a licensing structure that allows a customer to purchase utility credits 306 granting the customer use of a selected software product 302, or a range of software products 302, limited by a purchased amount of a specified usage metric. In general, utility credits 306 serve as a measure of permitted usage of a software product 302, and are associated with a usage metric that can be tracked by the system 202. Customers can select a software product 302 and purchase a selected number of utility credits 306 equating to a desired amount of product usage that the customer to be granted. Ownership of unused utility credits 306 permits a customer to use the software product 302, limited by the total amount of usage represented by the remaining unused utility credits 306. The system 202 tracks each customer's utility credits 306, software product permissions, and product usage histories in a dedicated customer record 304.

Once a customer has purchased a desired number of utility credits 306 for usage of a selected industrial software product 302, the software management system 202 tracks the customer's usage of the product by monitoring usage events 310, which are units of the usage metric associated with the utility credits 306. The usage metric can be substantially any measure of the product's usage, including but not limited to an amount of accumulated time that users associated with the customer entity have used the product 302, an amount of processing bandwidth consumed by the product 302 in connection with the customer's usage, an amount of storage space consumed by the product's usage, a number of processing cores or virtual machines used to execute the product 302, a number of times a specific feature of the product 302 is used (e.g., exporting data, generating a report, performing a specified type of calculation, executing a database query, etc.) or other such metrics. The customer's utility credits 306 are deducted, or consumed, as a function of the triggered usage events 310, and the system 202 issues activation controls 312 that either permit or prevent the customer's continued usage of the product 302 depending on whether the customer owns a sufficient number of unused utility credits 306 available for the product 302.

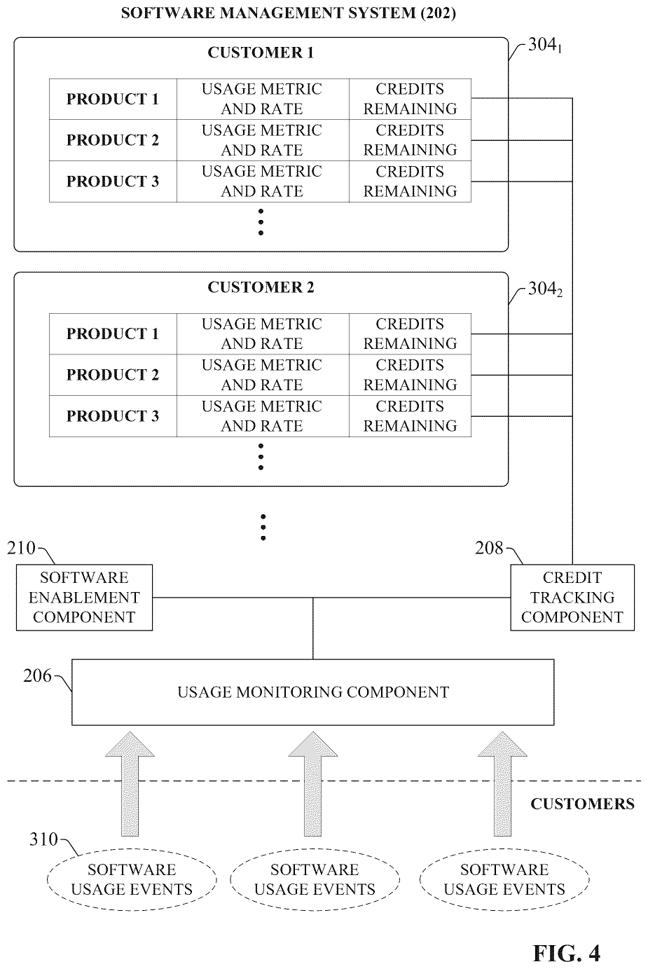

FIG. 4 is a diagram illustrating tracking of customers' utility credits by the software management system 202 according to one or more embodiments. As noted above, the system 202 can maintain customer records 304 corresponding to respective customers or customer entities (e.g., Customer 1, Customer 2, etc.) who are registered to access and use industrial software made available by the system 202. A customer entity may be, for example, an industrial enterprise comprising one or more industrial facilities, which makes use of industrial software for designing, programming, operating, and/or analyzing its industrial systems and processes.

Each customer record 304 can record the identities of software products 302 that the corresponding customer has purchased rights to access and use. For each product, the customer record 304 can also specify the usage metric to be used to track the customer's usage of the product 302 for the purposes of credit tracking. The usage metric may be, for example, an amount of time spent using the product 302 (which can be a cumulative time across multiple users associated with the customer entity, measured in units of seconds, minutes, hours, or days), an amount of processing power consumed by the product 302 (which may be a function of how the customer uses the product 302), an amount of storage space consumed by the product 302, a number of processing cores or virtual machines used by the product 302, or other such metrics. In some cases, customers can select a usage metric for a given product 302 based on their intended use of the product 302. In other cases, the usage metric associated with a software product 302 may be a fixed function of the product's type.

According to various example scenarios, a usage metric associated with a data collection or historian application may be an amount of storage space consumed by data collected and stored by the application, or an amount of time that the application is in use. In the case of an analytic software product that performs analysis on a customer's industrial data for the purposes of reporting, visualization, optimization, or supervisory control, the usage metric may be an amount of processing power or bandwidth consumed by the product 302, a number of discrete calculations performed by the product 302, a number of reports generated by the product 302, a number of processing cores on which the product 302 executes, or other such metrics of usage.

Each customer record 304 can also specify, for each product 302 that the customer is registered to use, a number of remaining usage credits 306 that have been purchased by the customer for use of the product 302. For a given product 302 and associated usage metric, the number of remaining (or unused) utility credits 306 represents an amount of the usage metric remaining to the customer for usage of the product 302. Once a customer has established an agreement to use a software product 302, specified a usage metric to be used as the basis for usage rights to the product 302, and purchased a number of utility credits 306 for the product 302, the system's usage monitoring component 206 tracks the customer's usage of the product 302 by monitoring usage events 310 corresponding to the usage metric selected for the product 302. As the customer uses the product 302, the credit tracking component 208 deducts from the customer's remaining utility credits 306 in response to detection of a usage event 310 by the usage monitoring component 206.

For example, if the usage metric for an industrial analytic software product is a number of discrete calculations performed by the product 302, the usage monitoring component 206 can monitor the customer's instance of the product 302 for calculations performed by the product 302, identifying each calculation as a usage event 310. In response to detection of this usage event 310, the credit tracking component 208 can decrement the customer's remaining utility credits 306 for the product by a number of utility credits 306 corresponding to the credit cost of a calculation (e.g., one utility credit 306 per calculation). If the usage metric is an amount of processing bandwidth or memory consumed by the product 302 during its execution, the usage monitoring component 206 can monitor the product's consumption of processing power (e.g., in terms of a peak amount of processing power consumed during execution, or in terms of cumulative processing bandwidth over time) or memory consumption as usage events 310, which trigger deductions or draw-downs of the number of available utility credits 306 by the credit tracking component 208. If the usage metric is set to be time of use, the usage monitoring component 206 can track, as usage events 310, each minute that a user associated with the customer is using the product 302, and these events 310 will trigger a commensurate deduction or draw-down of the available utility credits 306 by the credit tracking component 208.

As noted above, customers permitted to use a given software product 302 can either download an instance of the product 302 for local execution, or may remotely access and use a cloud-based or centralized instance of the product 302. In either case, the usage monitoring component 206 will monitor usage events 310 triggered by usage the product 302 on a customer-specific basis, and the credit tracking component 208 updates the number of remaining utility credits 306 recorded in each customer file 304 based on the corresponding customer-specific usage events. The system 202 can monitor the usage events 310 from local instances of the products 302 (e.g., instances executing on local assets 308, as illustrated in FIG. 3) and issue activation controls 312 to the local instances via any intervening network infrastructures and devices, including but not limited to the internet, an office network or plant network at the industrial facility, gateway devices, or other such network entities.

In general, the cost of a usage event 310, in terms of the number of utility credits 306 consumed by the event 310, can be defined at any level of granularity (e.g., one utility credit per event 310, three utility credits per event 310, etc.). Also, some embodiments can allow different utility credit costs, or credit draw-down rates, to be defined for respective different types of usage events 310 associated with the product 302. In the case of an analytic software products, a customer may agree to an arrangement whereby different types of calculations or events executed by the product 302 have different utility credit costs. For example, using the product 302 to generate and output a report may cost a first number of utility credits 306, while using the product 302 to send recipe data to a control system for execution may cost a second number of utility credits 306. Other types of discrete usage events 310 that can be associated with a utility credit cost in this manner can include, but are not limited to, executing a database query, performing a calculation that will require an unknown amount of processing time, converting a control project (e.g., converting control code from a first platform to a second platform), exporting a control project or control code, or other such events 310.

In this way, software-specific discrete events 310 are used as the method of charging for the use of the software products 302 on a transactional basis. Deducting from a customer's remaining number of available utility credits 306 in response to detection of monitored discrete usage events 310, where the amount by which the utility credits 306 are deducted is determined based on the defined utility credit cost of the event 310, effectively allows the customer's usage of the software product 302 to be metered. Customers can purchase any number of additional utility credits 306 at any time from the vendor of the software product 302. Once purchased, the credit tracking component 208 will add the new credits 306 to the current total of utility credits that are available to the customer for usage of the product 302.

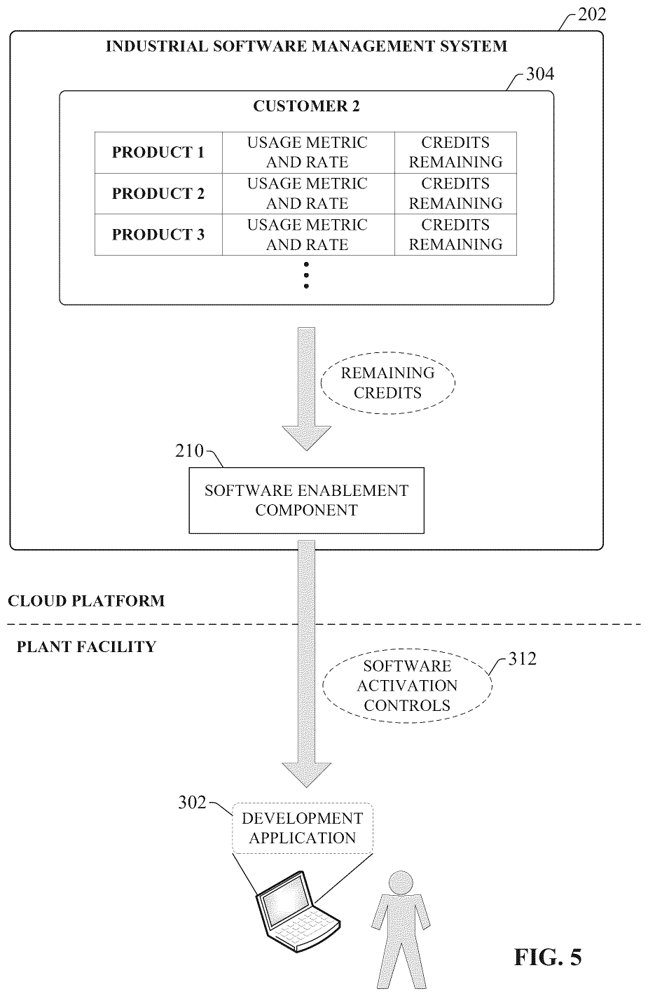

FIG. 5 is a diagram illustrating deployment of software activation controls 312 by the system 202. As a customer entity is using a software product 302 for which utility credits 306 have been purchased, the usage monitoring component 206 and credit tracking component 208 monitor the product's usage events 310 and deduct from the customer's available utility credits 306 for the product 302 accordingly, as described above. The software enablement component 210 monitors the customer's remaining unused utility credits 306 as recorded in the customer's record 304, and issues software activation controls 312 that either enable or disable use of the product 302 based on a determination of whether a sufficient number of remaining credits are available to use the product 302. That is, if the number of remaining utility credits 306 falls below a minimum number required to use one of the product's features, the software enablement component 210 issues an activation control 312 that disables that feature of the software product 302. Otherwise, if a sufficient number of utility credits 306 are available to use the feature, the software enablement component 210 issues an activation control 312 that permits usage of the product's feature. In order to re-enable the feature, or to prevent disablement of the feature before the number of remaining credits 306 falls below the minimum required, the customer can purchase additional utility credits from the vendor of the software product 302, which will be added to the number of available credits 306 recorded in the customer record 304.

Although the examples described above assume that the customer purchases a separate set of utility credits 306 for each individual product 302 to be licensed, such that the customer record 304 tracks separate numbers of available credits 306 for each product 302, in some embodiments the system 202 can allow the user to purchase utility credits 306 that are shared among all products 302 used by the customer. In such embodiments, the credit tracking component 208 manages a single pool of available utility credits 306 owned by the customer, and deducts from this pool of available credits 306 in response to usage events 310 generated by any product 302 used by the customer. The number of credits 306 decremented from the available credits 306 for a given event 310 can depend on the utility cost of the event 310, which itself may be a function of the particular product 302 that generated the event 310 and the type of the event 310.

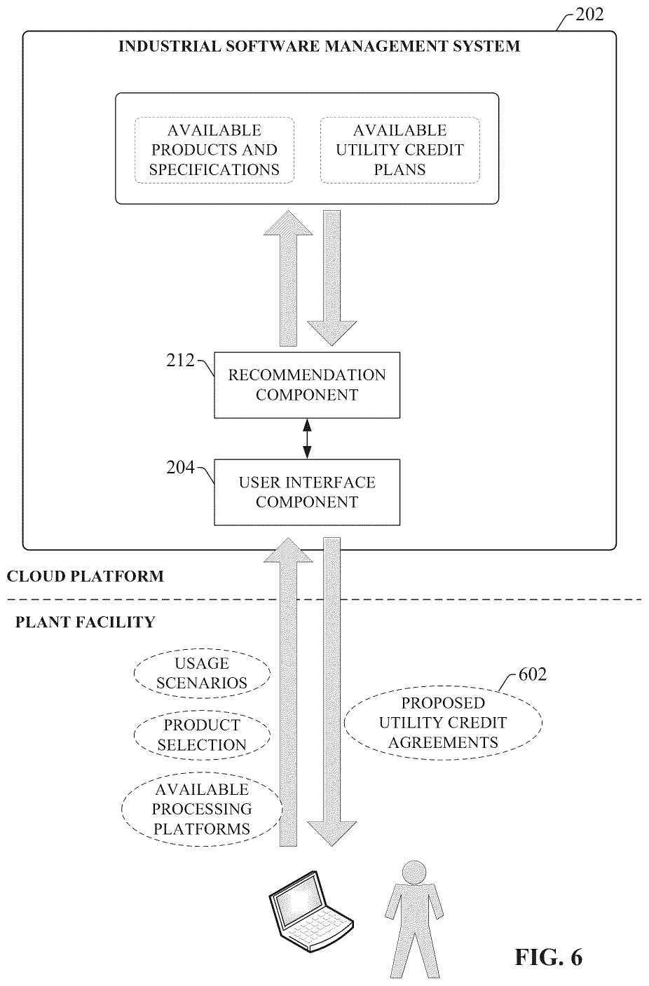

To assist customers in selecting a suitable utility credit agreement for use of a software product 302, some embodiments of the software management system 202 can generate recommendations for optimal utility credit agreements based on the customer's expected execution scenarios and available processing platforms. FIG. 6 is a diagram illustrating delivery of agreement recommendations 602 by the industrial software management system 202. In an example scenario, a customer in the process of selecting a utility credit agreement can submit information to the system 202 indicating the product 302 of interest as well as the customer's expected usage scenarios for the product 302. The submitted usage scenario information can depend on the type of software product 302 being considered. For example, in the case of an analytic software product 302, the usage scenario information can specify such information as the types of analytic tasks to be performed, a scope of the analytic tasks (e.g., number of machines or devices to be included in the analysis), a frequency at which analytic outputs are required, or other such information. In the case of development software products 302, the usage scenario information may specify an expected number of developers who will be using the product at the same time, a maximum size of control or visualization projects expected to be generated using the product 302, or other such usage scenarios. Additionally, in the case of software products 302 that will be executed locally at the customer facility, the customer may also submit information about processing platforms that are available to the customer for execution of the product 302, including the number available compute platforms and the respective processing capabilities of those platforms.

Based on the information submitted by the customer, the system's recommendation component 212 can generate one or more recommendations 602 for utility credit agreements that are suitable for the customer's expected usage scenarios and processing platforms, and the user interface component 204 can render these recommendations 602 on the customer's client device (e.g., via a web browser). In an example scenario, the recommendation component 212 may estimate the amount of time the software product 302 of interest will require to perform a specified computing task on each of the customer's available computer platforms (which may have respective different processing capabilities), as well as the utility credit costs associated with each of these estimates. In another example in which processing bandwidth is the usage metric measured by the utility credits 306, the recommendations 602 may comprise alternative tiered agreement proposals indicating the expected performance efficiency of the product 302 (e.g., in terms of the speed at which the product 302 can generate desired results) as a function of the number of utility credits 306 purchased. The recommendation component 212 can generate these estimates and proposals based on the available utility credit plans offered by the vendor of the software product 302, as well as performance specification information for the product 302 (e.g., the product's processing requirements, computing platforms on which the product 302 can be executed, etc.). The recommendations 602 may convey trade-offs between processing efficiency and the cost of different utility credit agreements, which can assist the customer in selecting a suitable agreement for use of the product 302.

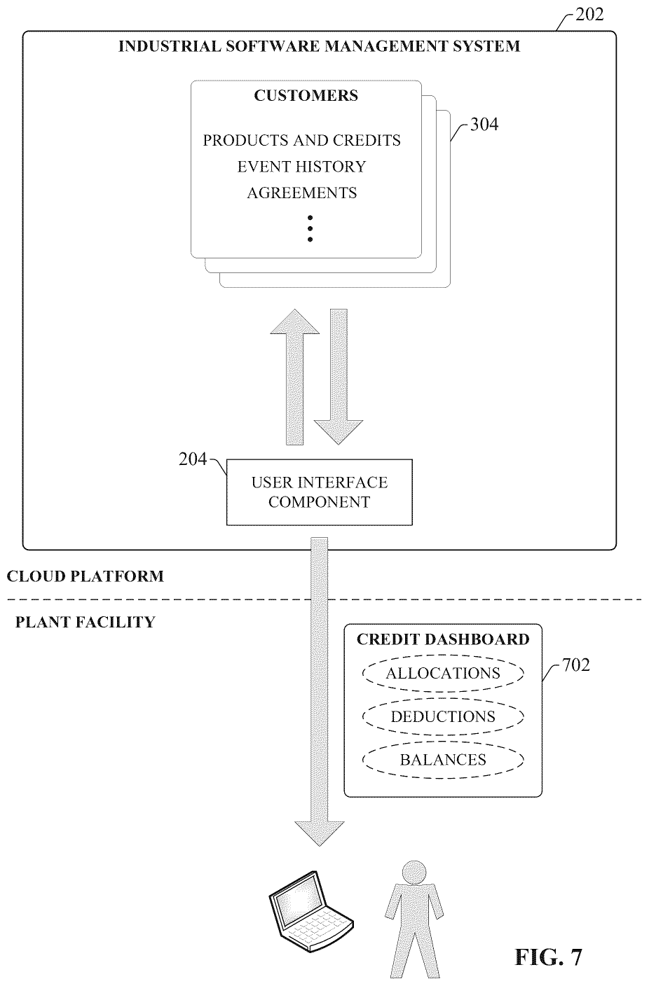

The software management system 202 can also allow customers with active utility credit agreements to access information about their utility credit allocations, deductions, balances, and usage history. FIG. 7 is a diagram illustrating generation and delivery of a customer-specific utility credit dashboard 702 to a client device associated with a corresponding customer. An authorized user associated with a customer can access the credit dashboard 702 via a web browser or another type of client application. The user interface component 204 renders, via the dashboard 702, such information as the customer's current utility credit balance, a history of allocations to and deductions from the customer's utility credits 306, a history of usage events 310 generated by each software product 302 used by the customer, details regarding the customer's current utility credit agreement, or other such information. The user interface component 204 can obtain at least some of the information presented on the dashboard 702 from the customer record 304 associated with the customer.

The credit-based approach for licensing industrial software products 302 described herein allows for simplified and flexible licensing agreements that can reduce the number of contracts the customer must maintain in order to operate multiple software products, since a common pool of utility credits 306 can be used to grant usage rights to multiple software products 306. This flexible licensing strategy, based on allotment and consumption of utility credits, can also encourage existing customers to try other products 306 offered by a vendor whose products the customer is already using, since the same pool of utility credits 306 can be used to unlock features of a range of different available products 302.

The licensing standard described above, in which utility credits 306 are used to enable features of industrial software products as a function of specified usage metrics, can be particularly useful for products 302 that operate on a substantially continuous basis, such as analytic applications that collect and analyze data from industrial operations for the purpose of generating reports, performing supervisory control, delivering notifications, optimizing plant operations, or other functions. While this licensing standard is also applicable to other types of software products 306, including design software or simulation software, that is used intermittently on an as-need basis, these types of software products 306 may also benefit from other types of licensing standards.

For example, according to another industrial software licensing standard described herein, subscription tokens can be allotted to customers and used to check out and use software products 302. These subscription tokens can determine how many instances of a software product 302 can be checked out and used by the customer at a given time.

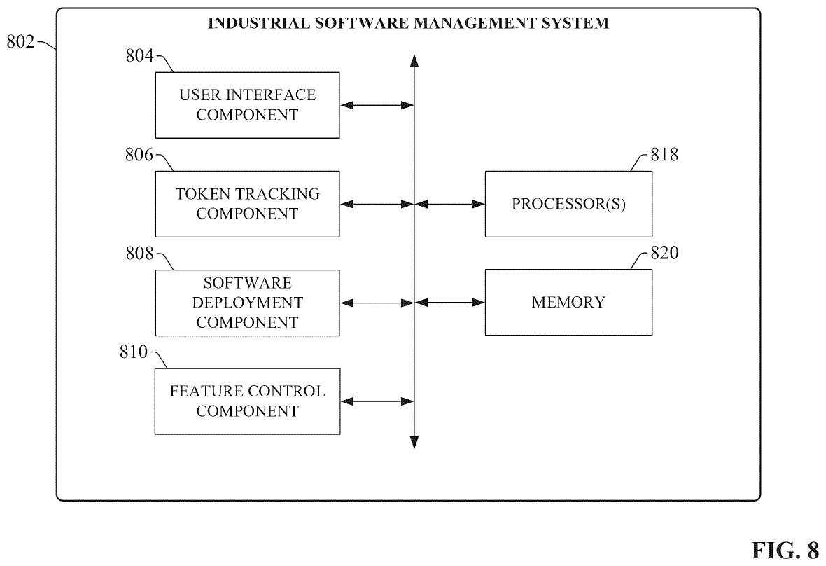

FIG. 8 is a diagram of an example industrial software management system 802 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Industrial software management system 802 can include a user interface component 804, a token tracking component 806, a software deployment component 808, a feature control component 810, one or more processors 818, and memory 820. In various embodiments, one or more of the user interface component 804, token tracking component 806, software deployment component 808, feature control component 810, the one or more processors 818, and memory 820 can be electrically and/or communicatively coupled to one another to perform one or more of the functions of the software management system 802. In some embodiments, components 804, 806, 808, and 810 can comprise software instructions stored on memory 820 and executed by processor(s) 818. Software management system 802 may also interact with other hardware and/or software components not depicted in FIG. 8. For example, processor(s) 818 may interact with one or more external user interface devices, such as a keyboard, a mouse, a display monitor, a touchscreen, or other such interface devices.

User interface component 804 can be configured to exchange information between the software management system 802 and client devices having authorization to access the system 802. In some embodiments, user interface component 804 can be configured to generate and deliver interface displays to the client device that allow the user to establish software licensing agreements, check out or check in software products, or perform other interactions with the system 802.

Token tracking component 806 can be configured to track and manage the number of unused or free subscription tokens that a customer currently has available, based on the number of instances of one or more software products 302 that are currently being checked out and used. Software deployment component 808 can be configured to deploy or activate instances of an industrial software product 302 on a client device associated with the customer entity, contingent on availability of an unused subscription token. Feature control component 810 can be configured to regulate user access to specific features of an industrial software product 302 based on availability of unused subscription tokens.

The one or more processors 818 can perform one or more of the functions described herein with reference to the systems and/or methods disclosed. Memory 820 can be a computer-readable storage medium storing computer-executable instructions and/or information for performing the functions described herein with reference to the systems and/or methods disclosed.

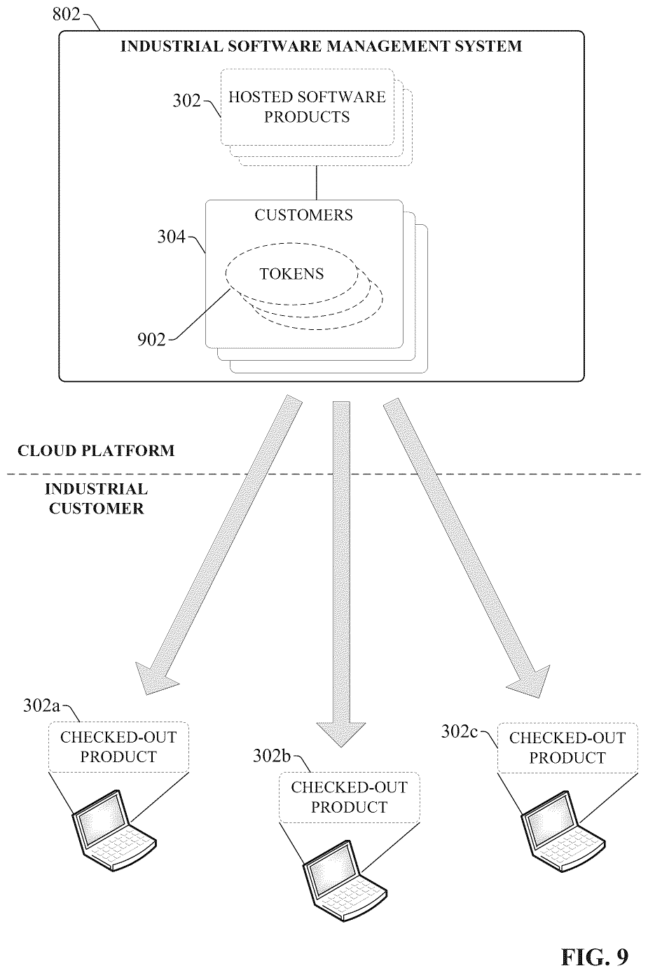

FIG. 9 is a diagram illustrating a general architecture of the industrial software management system 802 according to one or more embodiments. As with the industrial software management system 202 described above, software management system 802 can host a variety of industrial software products 302 for local or remote use by industrial customers. According to the licensing standard supported by system 802, an industrial customer can purchase any number of subscription tokens 902 for use by employees associated with the customer. The number of tokens 902 purchased by the customer correlates to the number of software products 302, or client instances of software products 302, that are permitted to be used by employees within the customer's organization at the same time. When a user associated with the customer submits a request to use a software product 302, the system 802 will permit the user to access and use the product 302 only if a sufficient number of unused, or free, subscription tokens 902 are available. If a sufficient number of unused tokens 902 are available, the system 802 allows the user to open and use the product 302. The system 802 also reduces the number of available subscription tokens 902 by an amount equal to a token cost associated with the selected product 302 while the user is using the product 302.

Multiple users may check out and use instances of the software products 302—which may include multiple instances of the same software product 302 or instances of different products 302—concurrently, provided the total token cost of the product instances that are concurrently in use does not exceed the total number of subscription tokens 902 that were purchased by the customer. Instances of software products 302 currently being used are considered checked-out by the user in exchange for a number of the customer's available, or free, subscription tokens 902. When a user relinquishes use of a checked-out product 302, the system 802 returns the subscription tokens 902 that had been deducted for use of the product 302 back to the customer's allotment of available subscription tokens 902.

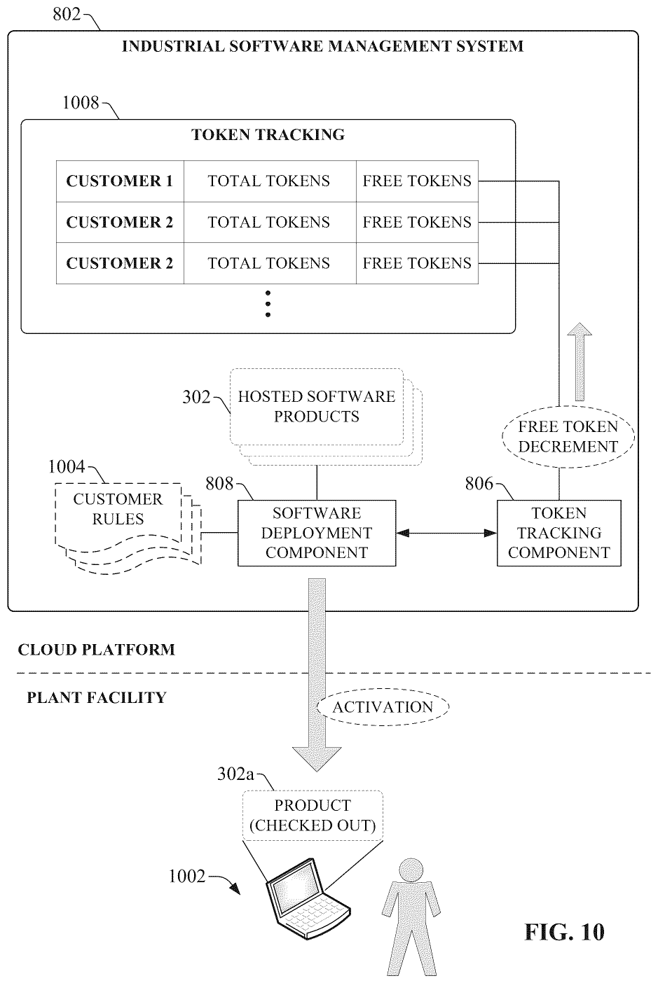

FIG. 10 is a diagram illustrating the process of checking out a software product 302 for use by a user associated with a customer entity according to one or more embodiments. In this example, software management system 802 maintains a record 1008 of the number of total subscription tokens 902 that each of multiple registered industrial customers (Customer 1, Customer 2, etc.) have purchased, or have otherwise been allotted. A customer's total allotment of subscription tokens 902 correlates to a total number of instances of software products 302 that can be checked out and used by employees within the customer's organization at the same time. The record 1008 also maintains, for each customer, an indication of the number of currently unused, or free, subscription tokens 902 that are available to the customer.

In the illustrated example, a user at client device 1002 has checked out an instance 302a of a software product 302 hosted by the software management system 802. In some cases, an instance 302a of a software product 302 may be a local copy of the product 302 that is executed and/or used on a compute platform associated with the customer (e.g., a client device 1002, a server, etc.). In other cases, the instance 302a may execute on the cloud platform, using the cloud-platforms computing resources, and the system 802 can serve a thin client to the customer's client device 1002 that allows the user to access and utilize the instance 302a of the product 302.

To invoke an instance 302a of a software product 302, a user associated with the customer can submit, to the software management system 802, a request for access to the selected product 302. In response to receipt of such a request, the token tracking component 806 can determine whether the customer has a sufficient number of free subscription tokens 902 to allow the user to access and use the selected product 302, depending on the token cost of the selected software product 302. In some embodiments, different software products 302 may be associated with different token costs. For example, control program development software may have a cost of two subscription tokens 902, while industrial emulation software may have a higher cost of five subscription tokens 902. When a user submits a request for a selected product 302, the token tracking component 806 will query the token tracking record 1008, and the software deployment component 808 will only permit the user to access and use the product 302 if the token tracking component 806 verifies that the customer's total number of free subscription tokens 902 is equal to or greater than the token cost of the requested product 302. Alternatively, if the token tracking component 806 determines that the customer's number of free subscription tokens 902 is less than the token cost of the product 302, the software deployment component 808 will disable or otherwise deny access to the product 302 by the user.

When a request to use a selected software product 302 is granted, the software deployment component 808 allows the user to open and use an instance 302a of the selected product 302. Additionally, the token tracking component 806 will decrement the customer's number of free subscription tokens 902 by an amount equal to the token cost of the product 302. The number of free subscription tokens 902 at any given time will be equal to or less than the total number of subscription tokens 902 that have been purchased by, or otherwise allotted to, the customer. The manner in which the instance 302a is activated can depend on whether the instance 302a is to be hosted locally on the user's client device 1002 or on the cloud platform by the software management system 802 itself. For example, the software deployment component 808 may send an activation signal or code to an instance 302a hosted on the client device 1002, or may initiate access to a cloud-hosted version of the product 302 via a thin client on the client device 1002.

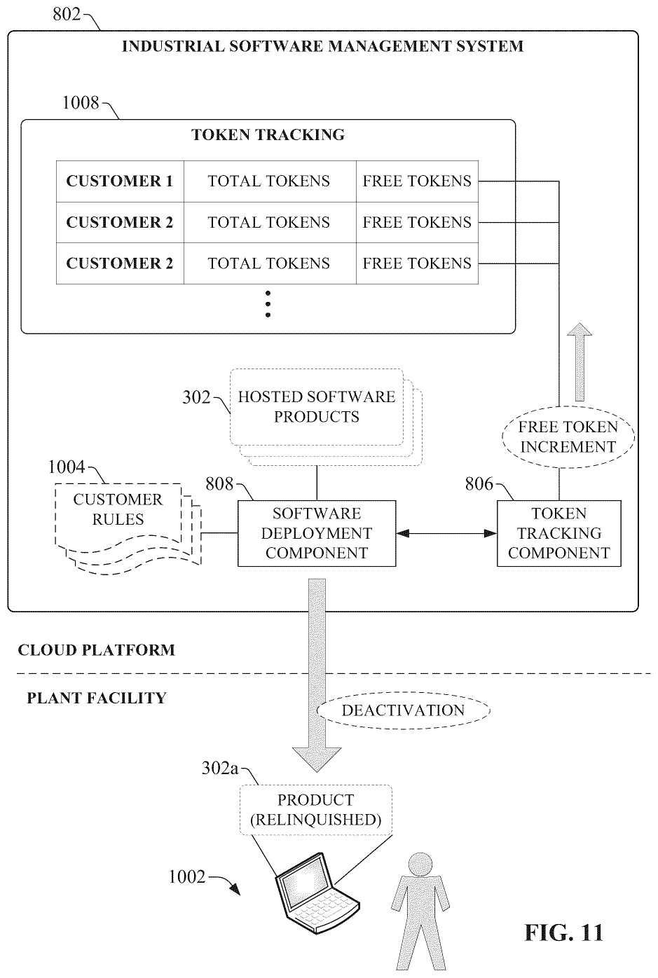

FIG. 11 is a diagram illustrating the process of relinquishing the instance 302a of the software product 302 according to one or more embodiments. When the user no longer wishes to use the software product 302, the user can submit, to the system 802, a request to relinquish use of the product 302. In response to this request, the software deployment component 808 disables the instance 302a of the product 302 on the user's client device 1002, and the token tracking component 806 increments the total number of free subscription tokens 902 available to the customer by a number equal to the subscription token cost of the product 302, thereby returning the used subscription tokens 902 to the pool of tokens available to other users within the customer's organization.

A customer's allotted subscription tokens can be shared across the customer's organization rather than being specific to a single employee. In this way, multiple users associated with the customer may check out instances 302a of the same software product 302 or other software products 302 using the approach described above. The number of free subscription tokens 902 available to the customer's organization at a given time will be the total number of subscription tokens 902 allotted to the customer minus the total token costs of all instances 302a of software products 302 that are currently active within the customer's organization. If the number of free subscription tokens 902 falls below the number required to activate another instance 302a of a product 302 due to the number and types of software product instances 302a currently in use, the software deployment component 808 prevents further product instances 302a from being enabled by users within the customer's organization until users relinquish a sufficient number of software instances 302a to increase the number of free subscription tokens 902 to a number sufficient to open a desired product instance 302a.

While a customer's allotment of subscription tokens are shared across the users within the customer's organization, some embodiments of the software management system 802 can support definition of granular customer rules 1004 that further regulate the degree of access to specific software products 302 based on user role. These customer rules 1004 can be customized for each registered customer and can define, for each of multiple user roles, a subset of the available software products 302 that can be checked out and used by users assigned to that role (or may explicitly define software products 302 that are prohibited to users assigned to the role). For example, a customer rule 1004 may specify that mechanical engineers are only to be permitted access to products 302 pertaining to mechanical engineering, but are prohibited from accessing program development products 302 or electrical engineering products 306. The software deployment component 808 can reference these rules 1004 in connection with determining whether to permit access to a requested product 302 by a user having a specific role, such that access to the product 302 is only permitted if a sufficient number of free subscription tokens 902 are available and the customer rules 1004 do not prohibit access to the requested instance 302a by users having the role. The software deployment component 808 can use any suitable technique to determine the role of the requesting user, including cross-referencing the identity of the user with an organizational chart submitted to the system 802. Example user roles for which customer rules 1004 can be defined include, but are not limited to, engineers of various disciplines, plant managers, accounting personnel, machine operators, sales personnel, or other such roles.

In some embodiments, subscription tokens 902 can be used to regulate access to specific features of a given software product 302, rather than permitting or denying access to all features of the product 302. For example, rather than, or in addition to, associating a token cost to each software product 302, different features of a product 302 may be assigned a token cost. When a user within the customer's organization begins using a feature having an associated token cost, the token tracking component 806 will deduct the number of free subscription tokens from the customer's total commensurate with the subscription token cost of the feature. If a user attempts to use a feature that is regulated using subscription tokens 902, the software deployment component 808 will only unlock the feature for use via the user's instance 302a if the customer's number of free subscription tokens 902 is equal to or greater than the token cost of the feature.

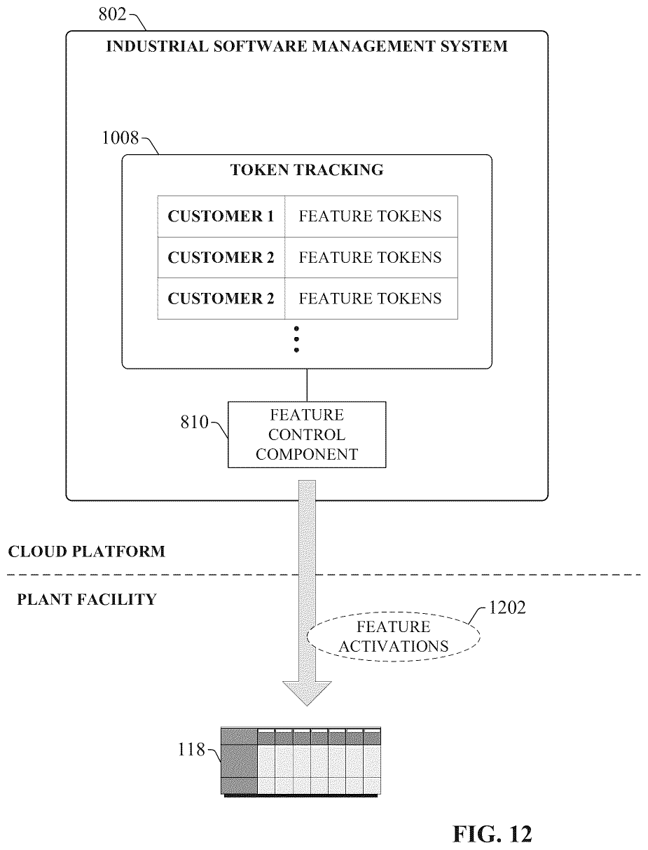

The subscription token use cases described above have considered scenarios in which subscription tokens 902 are used to regulate a customer's access to subscription software products 302, such as control system design products (e.g., controller programming applications, HMI development applications), that typically execute on general purpose computing platforms such as client devices 1002 or cloud platform computing resources. However, a variation of the subscription token approach can also be used to regulate a customer's use of runtime features within an industrial environment. FIG. 12 is a diagram illustrating an embodiment of the software management system 802 that uses feature tokens to license runtime features of industrial devices and systems. In general, feature tokens can act as a license to activate and use features of runtime industrial devices or systems, which operate substantially continuously in connection with performing industrial processes. Example runtime devices whose features can be licensed using feature tokens can include, but are not limited to, industrial controllers 118, HMI terminals 114, motor drives, industrial robots, or other such runtime systems.

Similar to subscription tokens 902, feature tokens can be purchased and allotted to a customer, and the system 802 can record the customer's purchased feature tokens in a record 1008. Feature tokens differ from subscription tokens 902 in that they unlock features of industrial devices that operate substantially perpetually in connection with monitoring and controller industrial systems, rather than being used to unlock software intended to be used more intermittently, such as industrial design software. Feature tokens may also be associated with specific runtime device features, such that the feature tokens allotted to a given customer correspond to respective features for which the customer has purchase a license. Example features that can be licensed in this manner can include, for example, specialized control features (e.g., the ability of an industrial controller to control axes of motion in motion systems), networking features (e.g., transmission control protocol (TCP) connection capability), access to expanded memory or processing capability, expanded I/O capacity, additional visualization features, access to specialized device configuration parameters, or other such features.

In an example scenario, a customer may purchase an industrial controller 118 having various features that can be selectively enabled according to license agreements. The customer may also purchase feature tokens that permit enablement of selected features of the controller 118 (e.g., motion control capability, expanded I/O, additional memory, automated notification capabilities, etc.). Upon power up, the controller 118 can send a request to the software management system 802 (e.g., via a gateway device or any other intervening networks and associated infrastructure devices) requesting activations for any features for which the customer has purchased feature tokens. The software management system's feature control component 810 can determine which features of the controller 118 the user has purchased a license to use based on the identities of the feature tokens that have been allocated to the customer, and can send feature activation data 1202 to the controller 118 that enables any features of the controller 118 for which the customer has purchased a feature token. These licensed features remain activated while the controller 118 is in use, thereby mitigating potential safety concerns that may arise due to disablement of a licensed feature while the controller 118 is actively performing control of an industrial machine or process. Although the example described in connection with FIG. 12 depicts an example in which feature tokens are used to unlock runtime features of an industrial controller 118, feature tokens can also be used to enable features of other types of runtime devices or systems.

The manner in which feature tokens are applied can depend on the customer's licensing agreement with the vendor of the runtime devices. For example, if a customer owns multiple units of a given runtime device and wishes to unlock a given feature on all such devices, a licensing agreement may require the customer to purchase a feature token corresponding to the feature for each device on which the feature is to be unlocked. Alternatively, the customer may enter into a licensing agreement in which a global feature token is purchased for a given feature, which permits the user to activate the corresponding feature on any number of devices owned by the customer.

In various embodiments, subscription tokens and feature tokens can be defined that correspond to various categories of software. These categories can include, but are not limited to, on-premises software, design software, operations software, maintenance software, or other industrial software types.

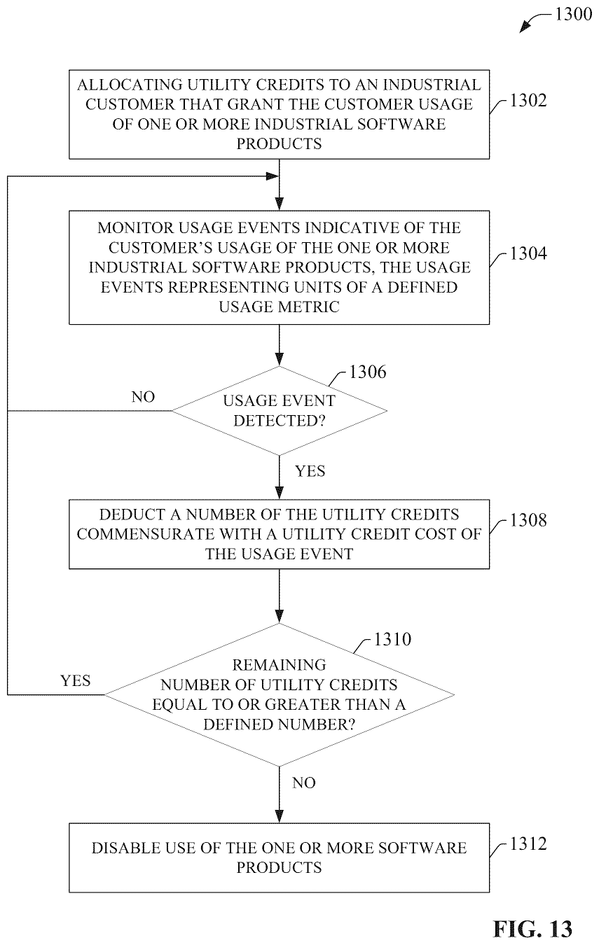

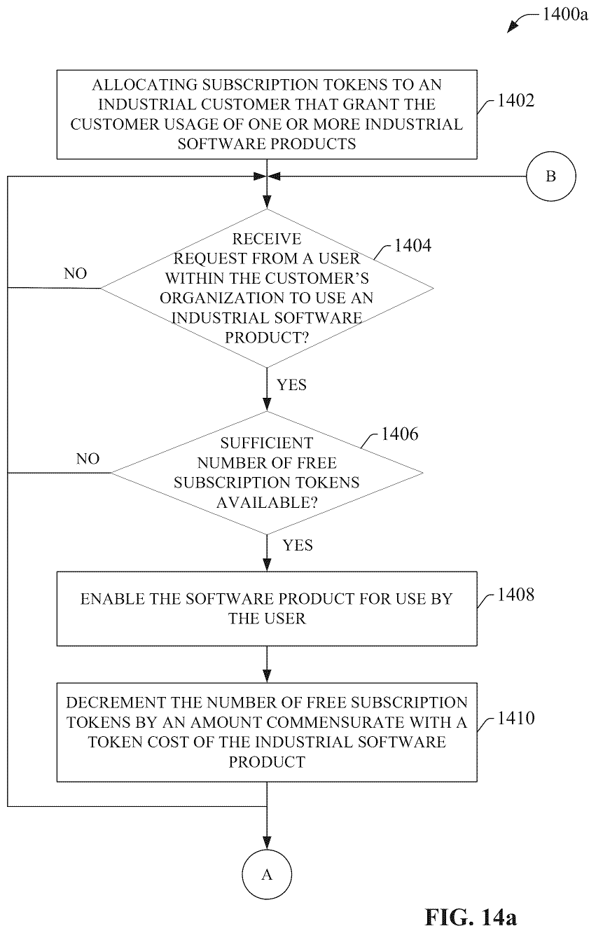

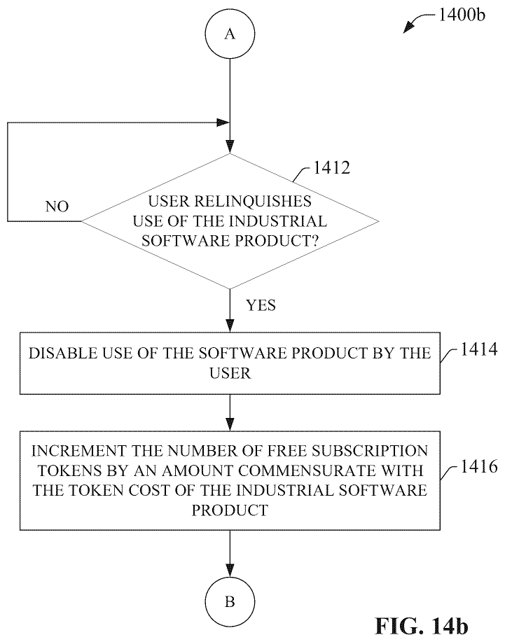

FIGS. 13-14b illustrate various methodologies in accordance with one or more embodiments of the subject application. While, for purposes of simplicity of explanation, the methodologies shown herein is shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 13 illustrates an example methodology 1300 for managing licensed use of industrial software products using utility credits. Initially, at 1302, utility credits are allocated to an industrial customer. The utility credits can be purchased by the customer under a licensing agreement with a software product vendor, and grant the customer permission to use one or more industrial software products on a transactional basis.

At 1304, usage events indicative of the customer's usage of the one or more industrial software products are monitored. The usage events represent units of a defined usage metric for which the utility credits were purchased. The usage metric can be substantially any measure of the product's usage, including but not limited to an amount of accumulated time that users within the customer's organization have used the product, an amount of processing bandwidth consumed by the product in connection with the customer's usage, an amount of storage space consumed by the product's usage, a number of processing cores or virtual machines used to execute the product, a number of times a specific feature of the product is used (e.g., exporting data, generating a report, performing a specified type of calculation, executing a database query, etc.) or other such metrics.

At 1306, a determination is made as to whether a usage event associated with the customer's use of the one or more software products is detected. If no usage event is detected (NO at step 1306), the methodology returns to step 1304 and monitoring of usage events continues. Alternatively, if a usage event is detected (YES at step 1306), the methodology proceeds to step 1308, where a number of the utility credits commensurate with a utility credit cost of the usage event is deducted.

At 1310, a determination is made as to whether the remaining number of utility credits (after the deduction made at step 1308) is equal to or greater than a defined number of utility credits that permits continued use of the one or more software products. If the remaining number of utility credits is equal to or greater than the defined number (YES at step 1310), the methodology returns to step 1304 and monitoring of the usage events continues. Alternatively, if the remaining number of utility credits is less than the defined number (NO at step 1310), the methodology proceeds to step 1312, where use of the one or more industrial software products (or a feature set thereof) is disabled.

FIG. 14a illustrates a first part of an example methodology 1400a for managing licensed use of industrial software products using subscription tokens. Initially, at 1402, subscription tokens are allocated to an industrial customer. The subscription tokens can be purchased by the customer under a licensing agreement with a software product vendor, and grant the customer permission to use one or more industrial software products in a manner that limits simultaneous access to the software products by users within the customer's organization.

At 1404, a request to use an industrial software product is received from a user within the customer's organization. In some embodiments, the request may be sent to a software management system in response to the user's attempt to open and use the software product. If the request to use the software product is received (YES at step 1404), the methodology proceeds to step 1406, where a determination is made as to whether a sufficient number of free, or unused, subscription tokens are available from the original allotment of subscription tokens to use the software product. The number of free subscription tokens required to use the product may depend on the type of the software product to which access is being requested. That is, different types of industrial software products may be associated with different token costs, which define the minimum number of free subscription tokens required to access and use that type of software product.

If a sufficient number free subscription tokens are not available (NO at step 1406), the methodology returns to step 1404 without permitting the user to access and use the software product. Alternatively, if a sufficient number of free subscription tokens are available to use the software product (YES at step 1406), the methodology proceeds to step 1408, where the software product is enabled for use by the user. Additionally, at step 1410, the number of free subscription tokens is decremented by an amount commensurate with the token cost of the industrial software product. The methodology returns to step 1404, and steps 1404-1410 are repeated to process additional requests to use the industrial software product or other industrial software products.

In parallel, the methodology proceeds to the second part 1400b illustrated in FIG. 14b. At 1412, a determination is made as to whether the user who was granted use of the software product at step 1408 has relinquished use of the product. If the user has relinquished use of the software product (YES at step 1412), the methodology proceeds to step 1414, where use of the software product by the user is disabled. Additionally, at step 1416, the number of free subscription tokens is incremented by an amount commensurate with the token cost of the industrial software product.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, Open Platform Communications Unified Architecture (OPC-UA), and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

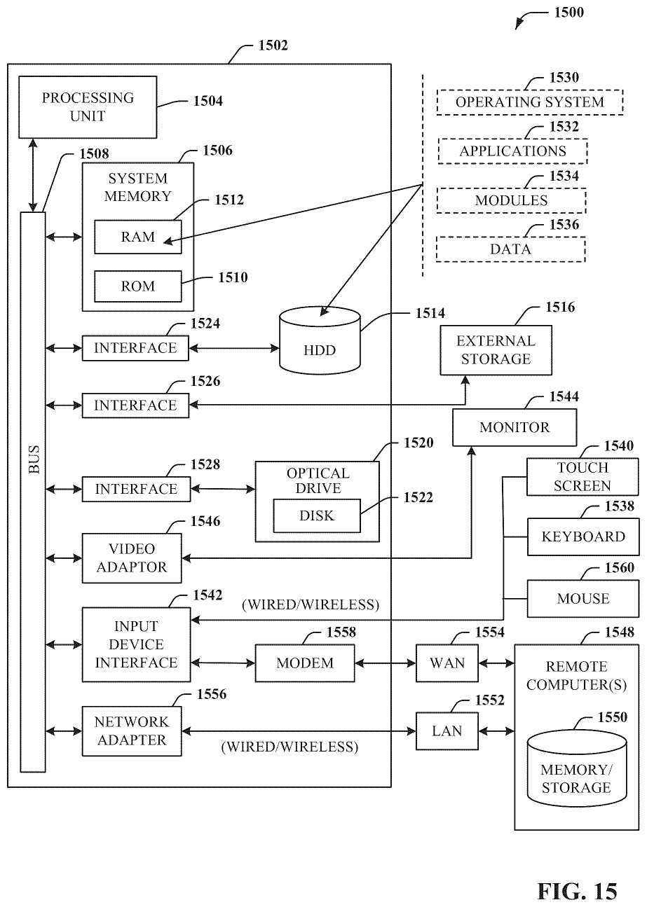

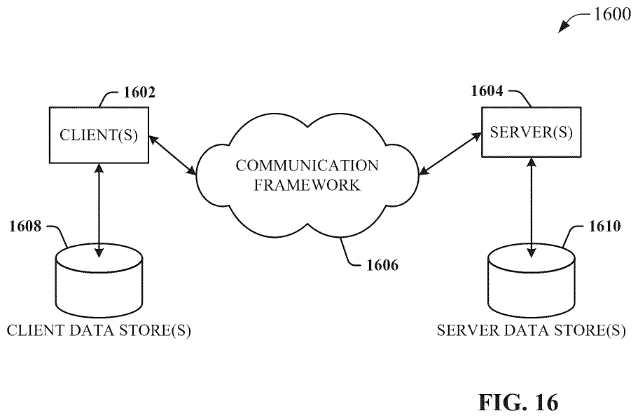

In order to provide a context for the various aspects of the disclosed subject matter, FIGS. 15 and 16 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1520 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid state drive (SSD) could be used in addition to, or in place of, an HDD 1514. The HDD 1514, external storage device(s) 1516 and optical disk drive 1520 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for application programs 1532. Runtime environments are consistent execution environments that allow application programs 1532 to run on any operating system that includes the runtime environment. Similarly, operating system 1530 can support containers, and application programs 1532 can be in the form of containers, which are lightweight, standalone, executable packages of software that include, e.g., code, runtime, system tools, system libraries and settings for an application.

Further, computer 1502 can be enable with a security module, such as a trusted processing module (TPM). For instance with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1560. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1544 or other type of display device can be also connected to the system bus 1508 via an interface, such as a video adapter 1546. In addition to the monitor 1544, a computer typically includes other peripheral output devices (not shown), such as speakers, printers, etc.

The computer 1502 can operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1552 through a wired and/or wireless communication network interface or adapter 1556. The adapter 1556 can facilitate wired or wireless communication to the LAN 1552, which can also include a wireless access point (AP) disposed thereon for communicating with the adapter 1556 in a wireless mode.

When used in a WAN networking environment, the computer 1502 can include a modem 1558 or can be connected to a communications server on the WAN 1554 via other means for establishing communications over the WAN 1554, such as by way of the Internet. The modem 1558, which can be internal or external and a wired or wireless device, can be connected to the system bus 1508 via the input device interface 1542. In a networked environment, program modules depicted relative to the computer 1502 or portions thereof, can be stored in the remote memory/storage device 1550. It will be appreciated that the network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1552 or WAN 1554 e.g., by the adapter 1556 or modem 1558, respectively. Upon connecting the computer 1502 to an associated cloud storage system, the external storage interface 1526 can, with the aid of the adapter 1556 and/or modem 1558, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 16 is a schematic block diagram of a sample computing environment 1600 with which the disclosed subject matter can interact. The sample computing environment 1600 includes one or more client(s) 1602. The client(s) 1602 can be hardware and/or software (e.g., threads, processes, computing devices). The sample computing environment 1600 also includes one or more server(s) 1604. The server(s) 1604 can also be hardware and/or software (e.g., threads, processes, computing devices). The servers 1604 can house threads to perform transformations by employing one or more embodiments as described herein, for example. One possible communication between a client 1602 and servers 1604 can be in the form of a data packet adapted to be transmitted between two or more computer processes. The sample computing environment 1600 includes a communication framework 1606 that can be employed to facilitate communications between the client(s) 1602 and the server(s) 1604. The client(s) 1602 are operably connected to one or more client data store(s) 1608 that can be employed to store information local to the client(s) 1602. Similarly, the server(s) 1604 are operably connected to one or more server data store(s) 1610 that can be employed to store information local to the servers 1604.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components; and
a processor, operatively coupled to the memory, that executes the executable components, the executable components comprising:
a credit tracking component configured to record an allocation of utility credits to an industrial customer in a customer record associated with the industrial customer, the utility credits granting usage of an industrial software product to the industrial customer; and
a usage monitoring component configured to monitor usage events indicative of the industrial customer's usage of the industrial software product, wherein the usage events are units of a usage metric having a defined cost of utility credits,
wherein
the credit tracking component is further configured to record a deduction of the utility credits in the customer record in response to detection of each of the usage events by the usage monitoring component, and
the computer executable components further comprise a software enablement component configured to enable one or more features of the industrial software product in response to determining that a total number of the utility credits is equal to or greater than a defined number of credits, and to disable the one or more features in response to determining that the total number of the utility credits is less than the defined number.

2. The system of claim 1, wherein the usage metric is at least one of an amount of accumulated time that users associated with the industrial customer use the industrial software product, an amount of processing bandwidth consumed by the industrial software product, an amount of storage space consumed by the industrial software product, a number of processing cores used to execute the industrial software product, or a number of times a feature of the industrial software product is used.

3. The system of claim 1, wherein the industrial software product is at least one of an industrial control program development application used to create executable control programs for industrial controllers, a human-machine interface (HMI) development application used to create visualization applications for execution on an HMI terminal, a device configuration application, an industrial analytic application, manufacturing execution system (MES) software, an enterprise resource planning (ERP) application, an industrial data historian application, industrial simulation software, industrial emulation software, or an industrial reporting application.

4. The system of claim 1, wherein the customer record defines allocations of utility credits for respective different industrial software products used by the industrial customer.

5. The system of claim 1, wherein the credit tracking component is configured to record deductions of the utility credits in response to detection of usage events received from multiple different industrial software products used by the customer entity.

6. The system of claim 1, wherein the customer record defines different utility credit drawdown rates for respective different features of the industrial software product, and the credit tracking component is configured to, in response to detection of a usage event, of the usage events, corresponding to a feature of the different features, set an amount of the deduction of the utility credits based on a utility credit drawdown rate, of the utility credit drawdown rates, corresponding to the feature.

7. The system of claim 1, further comprising a recommendation component configured to generate one or more recommended licensing agreements for use of the industrial software product based on a definition of an expected usage scenario of the industrial software product or specification of processing platforms associated with the industrial customer that are available for execution of the industrial software product.

8. The system of claim 1, further comprising a user interface component configured to render, on a client device associated with the industrial customer, a credit dashboard that displays at least one of a current balance of the utility credits, a history of allocations to and deductions from the utility credits, a history of the usage events generated by the industrial software product, or information regarding a current utility credit agreement.

9. The system of claim 1, wherein the utility credits are purchased by the industrial customer under a licensing agreement between the industrial customer and a vendor of the industrial software product.

10. A method, comprising:
allocating, by a system comprising a processor, utility credits to an industrial customer, wherein the utility credits grant usage of an industrial software product to the industrial customer;
monitoring, by the system, usage events indicative of the industrial customer's usage of the industrial software product, wherein the usage events are measures of a usage metric having a defined cost of utility credits; and
in response to detecting a usage event of the usage events:
deducting, by the system, a number of the utility credits commensurate with the defined cost of utility credits;
in response to determining that a remaining number of the utility credits is equal to or greater than a defined number of utility credits, enabling, by the system, one or more features of the industrial software product; and
in response to determining that the remaining number of the utility credits is less than the defined number of utility credits, disabling, by the system, the one or more features.

11. The method of claim 10, wherein the usage metric is at least one of an amount of accumulated time that users associated with the industrial customer use the industrial software product, an amount of processing bandwidth consumed by the industrial software product, an amount of storage space consumed by the industrial software product, a number of processing cores used to execute the industrial software product, or a number of times a feature of the industrial software product is used.

12. The method of claim 10, wherein the industrial software product is at least one of an industrial control program development application used to create executable control programs for industrial controllers, a human-machine interface (HMI) development application used to create visualization applications for execution on an HMI terminal, a device configuration application, an industrial analytic application, manufacturing execution system (MES) software, an enterprise resource planning (ERP) application, an industrial data historian application, industrial simulation software, industrial emulation software, or an industrial reporting application.

13. The method of claim 10, wherein the allocating comprises allocating utility credits for respective different industrial software products used by the industrial customer.

14. The method of claim 10, further comprising:
defining, by the system, different utility credit drawdown rates for respective different features of the industrial software product; and
in response to detection of a usage event corresponding to a feature of the different features, deducting, by the system, the utility credits by an amount determined based on a utility credit drawdown rate, of the utility credit drawdown rates, corresponding to the feature.

15. The method of claim 10, further comprising generating, by the system, one or more recommended licensing agreements for use of the industrial software product based on information regarding an expected usage scenario of the industrial software product or information regarding processing platforms associated with the industrial customer that are available for executing the industrial software product.

16. The method of claim 10, further comprising rendering, by the system on a client device associated with the industrial customer, a credit dashboard that displays at least one of a current balance of the utility credits, a history of allocations to and deductions from the utility credits, a history of the usage events generated by the industrial software product, or information regarding a current utility credit agreement.

17. The method of claim 10, wherein the utility credits are purchased by the industrial customer under a licensing agreement between the industrial customer and a vendor of the industrial software product.

18. A non-transitory computer-readable medium having stored thereon instructions that, in response to execution, cause a system comprising a processor and executing on a cloud platform to perform operations, the operations comprising:
allocating utility credits to an industrial customer, wherein the utility credits grant permission to use an industrial software product to the industrial customer;
monitoring usage events indicative of the industrial customer's usage of the industrial software product, wherein the usage events are measures of a usage metric having a defined cost of utility credits; and
in response to detecting a usage event of the usage events:
subtracting a number of the utility credits equal to the defined cost of utility credits;
in response to determining that a remaining number of the utility credits is equal to or greater than a defined number of utility credits, enabling one or more features of the industrial software product; and
in response to determining that the remaining number of the utility credits is less than the defined number of utility credits, disabling the one or more features.

19. The non-transitory computer-readable medium of claim 18, wherein the usage metric is at least one of an amount of accumulated time that users associated with the industrial customer use the industrial software product, an amount of processing bandwidth consumed by the industrial software product, an amount of storage space consumed by the industrial software product, a number of processing cores used to execute the industrial software product, or a number of times a feature of the industrial software product is used.

20. The non-transitory computer-readable medium of claim 18, wherein the industrial software product is at least one of an industrial control program development application used to create executable control programs for industrial controllers, a human-machine interface (HMI) development application used to create visualization applications for execution on an HMI terminal, a device configuration application, an industrial analytic application, manufacturing execution system (MES) software, an enterprise resource planning (ERP) application, an industrial data historian application, industrial simulation software, industrial emulation software, or an industrial reporting application.
